(19) United States
(12) Patent Application Publication
(10) Pub. No.: US 2004/0117256 A1
(43) Pub. Date: Jun. 17, 2004

(54) Methods of marketing a mass consumer product

(76) Inventors: Celine Brucker, New York, NY (US); Joseph Campinell, Old Greenwich, CT (US); Carol Hamilton, New York, NY (US); Lucy Martinez, New York, NY (US)

Correspondence Address: Thomas L. Irving, FINNEGAN, HENDERSON, FARABOW,, GARRETT & DUNNER, L.L.P., 1300 I Street, N.W., Washington, DC, 20005-3315, US

(21) Appl. No.: 10/633,613

(22) Filed: Aug. 5, 2003

Related U.S. Application Data
(60) Provisional application No. 60/433,789, filed on Dec. 17, 2002.

(51) Int. Cl. G06F 17/60

(52) U.S. Cl. 705/14

(57) ABSTRACT

A method of marketing a mass consumer product may comprise providing retail establishments with quantities of the mass consumer product and broadcasting a program of at least about 10 minutes in duration. The program may contain information about the mass consumer product. The method may further comprise, during the program, encouraging the consumers to request an incentive associated with a prospective purchase of the product and enabling consumers who visit at least one of the retail establishments to redeem the incentive at the time of obtaining the product.

This application claims the benefits of priority of U.S. Provisional Application No. 60/433,789, filed Dec. 17, 2002, which is incorporated herein by reference.

### BACKGROUND

1. Field

This invention relates to methods of marketing a mass consumer product through the use of a broadcast program. More specifically, the invention pertains to marketing a consumer product through a broadcast program that encourages viewers via an incentive such as a coupon, for example, to visit a retail outlet for prospective purchase of the product which is the subject of the program. By way of example, the method of marketing discussed herein may be used to market a beauty care product, such as a multi-step hair coloring kit.

2. Related Art

Commercials, such as those aired on television and/or radio, have long been used to market consumer products to the mass market, i.e., to market mass consumer products. Typically, such commercials are relatively brief in nature, having time slots which are bought and sold in 15 second and 30 second increments, for example. In such commercials, information about the product being sold or marketed generally is relatively limited and focused on brand identification and core information about the general nature of the product. These commercials typically do not provide the viewer (or listener in the case of radio) with detailed information about the product being advertised, such as, for example, a detailed demonstration of the use of the product.

Also, though some commercials offer the consumer the opportunity to purchase the product directly from the commercial, such as by providing an address or phone number during the commercial which a consumer may contact to purchase the product, many commercials do not offer the consumer the opportunity to respond directly to the commercial, such as by phoning in, mailing in, or otherwise. Instead, the commercial may refer the viewer generally to types of retail establishments that may carry the product for sale. In many cases, however, commercials provide no information whatsoever about how or where consumers can obtain the product being advertised.

A more recent method of marketing a consumer product involves the airing of what is known as an “infomercial.” Infomercials are television programs that also attempt to sell a product and are generally longer than commercials. For example, infomercials may be up to about one half of an hour to an hour long. Time slots for infomercials typically are sold in increments of 1 minute, 2 minutes, or 30 minutes. Due to the increased duration, more information about the product being marketed may be given in an infomercial than in a commercial. For example, infomercials may contain more details regarding use of the product and/or testimonials of various individuals' “real-life” experiences with the product.

Moreover, the sales and distribution business model typically associated with infomercials includes the direct sale of the product to the consumer through the infomercial. Thus, infomercials generally supply a phone number or other contact information for consumers who wish to purchase the product directly, rather than referring the consumer to a retail establishment to purchase the product. Even if a product on an infomercial is incidentally available through a retail establishment, the infomercial typically does not direct consumers to a retail establishment to obtain the product, but instead seeks to elicit immediate purchase through the contact source itself.

The difference in the sales and distribution business models associated with commercials and infomercials has been such that typical mass market producers who rely on retail establishments tend toward commercials, while infomercials have traditionally been used by those producers of goods in which sales and/or production have not reached mass marketing levels. In most of those cases, the product being advertised on the infomercial may be sold directly through contact information provided in the infomercial itself without directing consumers to retail establishments.

A disadvantage of using commercials to market a mass consumer product may be the relatively short duration of such commercials. This may be especially true for products that are relatively complex in nature or that may benefit from more information being conveyed to consumers than can be provided in the time limits associated with a commercial.

Infomercials often do not lend themselves to mass marketing of mass consumer products, for it may not be desirable for mass market producers to sell products directly to consumers in this fashion since their main sales distribution method is through retail establishments.

### SUMMARY OF A FEW ASPECTS OF THE INVENTION

It may be desirable to provide a method of marketing mass consumer products that permits more information about the product to be conveyed to potential consumers. For example, it may be desirable to broadcast a program of relatively long duration that provides information about a mass consumer product. By way of example, it may be desirable, during the program, to demonstrate how to use the product, such as a multi-step beauty care product.

It may be particularly beneficial to use this type of marketing for mass consumer products which have aspects, such as their manner of their use, that are not necessarily self-evident from a brief introduction to the product via a traditional commercial or from a cursory review of the product packaging material.

Various mediums may be used to broadcast a program. For example, the program may be broadcast via any of television, cable, satellite, radio, internet, CD, DVD, tape, and other suitable broadcast media.

It also may be desirable to continue to sell such mass consumer products which are the subject of the broadcast program through retail establishments that are visited by consumers as opposed to directly through contact information provided in the broadcast program.

Further, it may be desirable during the program about the product to encourage consumers to request an incentive, such as a coupon, for example, to encourage the consumer to visit at least one retail establishment that offers the product and redeem the incentive at the time of obtaining the product.

It also may be desirable to provide viewers with a designated source of further information during the program, for example via a direct response approach, about the product which is the subject of the program. In this regard, it may further be desirable to have the designated source also be the source through which consumers may request the incentive.

It should be understood that the invention could be practiced without performing one or more of the aspects, object, and/or advantages described herein. Other aspects will become apparent from the detailed description which follows.

As embodied and broadly described herein, an exemplary aspect of the invention may include a method of marketing a mass consumer product comprising providing retail establishments with quantities of the mass consumer product and broadcasting a program of at least about 10 minutes in duration, the program containing information about the mass consumer product The method may further comprise, during the program, encouraging the consumers to request an incentive associated with a prospective purchase of the product. Further, the method may comprise enabling consumers who visit at least one of the retail establishments to redeem the incentive at the time of obtaining the product.

Another exemplary aspect may include a method of marketing a mass consumer personal treatment product which comprises broadcasting a program of at least about 10 minutes in duration and, during the broadcasted program, demonstrating a multi-step process using the mass consumer personal treatment product. At least a portion of the demonstrating of the process may be performed by at least one individual whose likeness appears on packaging associated with the personal treatment product. The method may further comprise during the broadcasted program, providing consumers with contact information to receive an incentive for prospective purchase of the product and fielding requests from consumers to receive the incentive. The method also may comprise transmitting the incentive to requesting consumers and encouraging consumers to redeem the incentive during a visit to at least one retail establishment in connection with obtaining the mass consumer personal care product.

According to yet another exemplary aspect, a broadcast medium may comprise a program of at least about 10 minutes in duration, the program comprising information about a mass consumer product which is provided in quantities to retail establishments. The program may further include encouraging consumers to request an incentive associated with a prospective purchase of the product. The incentive may be redeemed by the consumers during a visit to at least one of the retail establishments at the time of obtaining the product.

According to yet another exemplary aspect, the programs discussed above are about 30 minutes in duration.

### BRIEF DESCRIPTION OF DRAWINGS

Besides the structural and procedural arrangements set forth above, the invention could include a number of other arrangements, such as those explained hereinafter. It is to be understood that both the foregoing description and the following description are exemplary. The accompanying drawings are included to provide a further understanding of the invention and are incorporated in and constitute a part of this specification. The drawings illustrate exemplary embodiments, together with the description, serve to explain certain principles. In the drawings,

FIG. 1 is a flow chart showing exemplary steps for marketing a mass consumer product according to an exemplary aspect of the invention;

FIG. 2 is an exemplary illustration of a direct response approach for marketing a consumer product according to an exemplary aspect of the invention;

FIG. 3A is an exemplary schematic illustration showing another aspect of an exemplary method of marketing a multi-step hair coloring kit according to an exemplary aspect of the invention;

FIG. 3B schematically illustrates various exemplary components that may constitute Step 31 of FIG. 3A;

FIG. 3C schematically illustrates various exemplary components that may constitute Step 34 of FIG. 3A

FIG. 4 illustrates another exemplary aspect of the contents of the program of FIG. 3A.

### DETAILED DESCRIPTION OF DRAWINGS

Reference will now be made in detail to exemplary embodiments, examples of which are illustrated in the accompanying drawings.

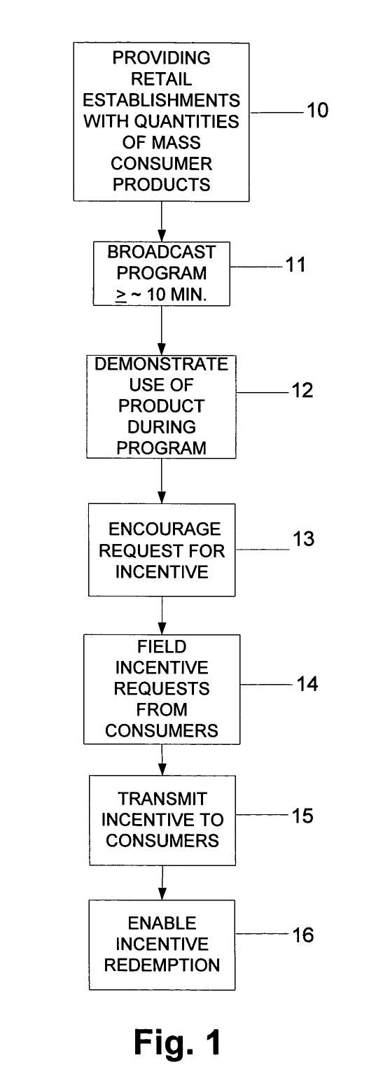

In an exemplary embodiment, a method for marketing a product, which may be a mass consumer product, for example, may comprise the various steps schematically illustrated in FIG. 1. As illustrated by step 10, the method may include providing retail establishments with quantities of mass consumer products. As used herein, the term “providing” broadly refers to any amount of facilitation or cooperation in channeling the product to a retail establishment. It can include one or more of directly manufacturing and shipping the product to the retail establishment; drop shipping to the retail establishment; contracting with another to ship to the retail establishment; or cooperating with another who provides the products to the retail establishment. The term “retail establishment” as used herein includes all locations where consumers are capable of purchasing products.

A “mass consumer product” as used herein is one intended to be widely available in a plurality of venues, and which is typically distributed to the mass market through retail supply chains. This contrasts with novelty products which are sold under other schemes, such as infomercials and direct sales mechanisms other than retail distribution and sales models. “Mass consumer products,” as used herein, further are envisioned as encompassing a wide variety of consumer products, including but not limited to, electronic products, household products, personal care and cosmetic products, including hair products and make-up products for example, health care products, personal hygiene products, cooking products, and other goods that are typically sold through retail distribution channels.

As indicated by reference numeral 11 in FIG. 1, the method may next include broadcasting a program of at least about 10 minutes in duration. By way of example, the duration of the program may range from about 10 minutes to about 3 hours. In another example, the duration of the program may range anywhere from about ½ hour to about 1 hour.

The program may be an audiovisual program broadcast over the airwaves, cable, internet, satellite, or any other broadcast medium, and/or an audio program (e.g., radio) broadcast through the medium mentioned above. Alternatively, or in addition to, “broadcast” may be achieved by providing consumers with a medium containing the program, for example, tape, CD, DVD, or any other media that the consumer is capable of playing at home, work, or on a mobile display platform.

The program may contain information that educates consumers about the product being sold via the program, for example, providing more detailed information regarding the product than would typically be provided in a conventional commercial.

According to an exemplary aspect, shown by reference numeral 12 in FIG. 1, the program may demonstrate how to use the product. For example, the program may demonstrate the various steps of a multi-step beauty care process, such as, a multi-step hair coloring process. Further details regarding exemplary contents of such a program for marketing a multi-step hair coloring process are provided below in greater detail.

Additionally, during the program, as shown in reference label 13, an incentive for purchasing the product may be offered to consumers and consumers may be encouraged to request such an incentive for prospective purchase of the product. That is, consumers may not be provided with an opportunity to immediately order the product as is typically the case with infomercials. Rather, the consumer may only be provided with an incentive to purchase a product in the future from a retail establishment. In this way, the broadcast does not undermine existing mass marketing sales channels, but rather encourages sales through those channels.

The incentive may be a coupon, and consumers may be encouraged to contact a designated source to request the coupon. The coupon could include a gift certificate for an amount of money toward the purchase of the product and/or may include an amount of money to be reduced from the price of the product upon purchase, for example.

Other incentives that may be offered and that are considered within the scope of the invention may include an onsite rebate triggered at the time of purchase by an oral request of the consumer, a mail-in rebate certificate or other type of mail-in rebate mechanism, a free gift to the consumer at the time of obtaining the product and mention of the program, or any other give away or price reduction intended to motivate the consumer to visit a retail establishment and obtain the product.

In the case of a coupon incentive, the designated source which consumers may be encouraged to contact to obtain the coupon may be, for example, a call center, in which case a telephone number, such as a toll free number, for example, may be provided during the program. The designated source also may be an internet website, for example. Of course, both a website address and a phone number may be provided during the program. Other designated sources may include a mailing address. Indeed, any mechanism for obtaining the incentive is to be considered within the scope of the invention.

Further, the provision of the contact information and encouragement to contact the designate source to request the incentive may occur several times throughout the program.

In response to the incentive offer, customers will seek the incentives, and the invention further may include fielding those requests, as indicated by step 14 of FIG. 1. This may occur through live personal contact, an interactive voice response (IVR) system, web response, or other personal or automated intervention. Upon a consumer contacting the designated source, personal information of the consumer, for example the consumer's postal and/or electronic mail address, may be obtained and an incentive, for example, a coupon may be transmitted to the consumer. The incentive may be redeemable at the time of obtaining the product at a retail establishment. For example, if the incentive is a coupon, it may be redeemable for purchase of the product at a discounted price during the visit by the consumer to the retail establishment.

The personal information may be provided over the telephone by the consumer to a telephone operator (or virtual operator) when the consumer calls the number provided during the program. Alternatively, if the consumer visits a website address, which also may be provided during the program, the consumer may be prompted upon accessing the website to enter certain personal information, including a post office address to which the coupon can be mailed and/or an electronic mail address to which the coupon may be transmitted electronically for printing by the consumer.

In an exemplary aspect, the incentive (e.g., coupon) which is transmitted to a consumer (e.g., as shown by reference numeral 15 in FIG. 1) may be personalized, for example, with the consumer's name printed thereon, and/or be accompanied by a personalized letter to the consumer. The incentive may also be a customized purchase incentive, for example an incentive to buy a particular product type, such as a particular product shade, or a combination of particular products that are best suited for the consumer to which the incentive is transmitted. According to another example, the transmitted coupon may be accompanied by a list of retail establishments that supply the product and are located in a geographical area in physical proximity to the consumer. Further, in instances in which the consumer has asked for further information or advice on product selection in conjunction with a request to obtain the coupon, as will be explained in more detail below, the transmission of the coupon may be accompanied by written advice or information requested by the consumer, or by other information based on personal information obtained by the consumer during the consumer's contacting the designated source. As an example, when marketing a hair coloring kit, based on personal information supplied by the consumer, an individual shade/color palette selection may be provided to the consumer, as will be explained further below.

According to another exemplary aspect, each coupon may be provided with a unique code so as to gain further information for marketing the product in the future, for example. The code may be used to track which consumers of those to whom coupons were transmitted have redeemed the coupon for purchase of the product and which consumers have not. As an example, the code assigned to each coupon may contain information about whether the coupon was obtained from a consumer who phoned in to obtain the coupon or from a consumer who visited the website to obtain the coupon. As another example, the code assigned to each coupon may identify the consumer to which the coupon was transmitted, for example via the personal information that may be gathered at the time the consumer contacted the designated source provided in the television program to obtain the coupon. Of course, those skilled in the art would understand the code assigned to each coupon could contain several other types of information, including, but not limited to, one or both of those described above.

Use of the code assigned to a coupon may include, for example, sending requests to complete surveys via postal mail or electronic mail to consumers who redeemed the coupon and purchased the product. The surveys may ask the consumer to provide a review of the consumer's experience using the product, for example. As another example, future re-marketing of the product may be performed by using the code to send direct mailing advertisements and/or reminders to use the product again to consumers who redeemed the coupon. For consumers who have not redeemed the coupon, reminders also may be sent reminding those consumers of their coupon and that it can be redeemed at a retail establishment for purchase of the product. Alternatively or additionally, further incentives and/or information on the product may be sent to any consumer to whom a coded incentive was transmitted in order to encourage purchase or repurchase of the product over time.

As another example, the code and/or other information gathered from consumers who contact the designated source may be used to generate profiles of consumers and to categorize those consumers based on the profiles generated. One exemplary category that may be created based on the consumer profiles includes a special (e.g., “club”) category indicating frequent purchase, use, and/or contact of the designated source. Consumers in this “club” category may receive special incentives, offers, and/or other advantages as a result of being in the club. Other uses of the code are considered within the scope of the invention.

In any event, the incentive preferably contains information reflecting its authenticity, thereby enabling it to be redeemed (reference numeral 16 in FIG. 1). In the case of a coupon incentive, the coupon may contain a code or redemption instructions for the merchant or consumer. In the case of a paperless incentive, an electronic record might be created recording that the incentive is redeemable by the consumer.

The order of the various steps presented in the figures is not intended to be limiting of the invention. For example, in an exemplary embodiment, the consumer may be encouraged first to purchase the product and thereafter to seek the incentive.

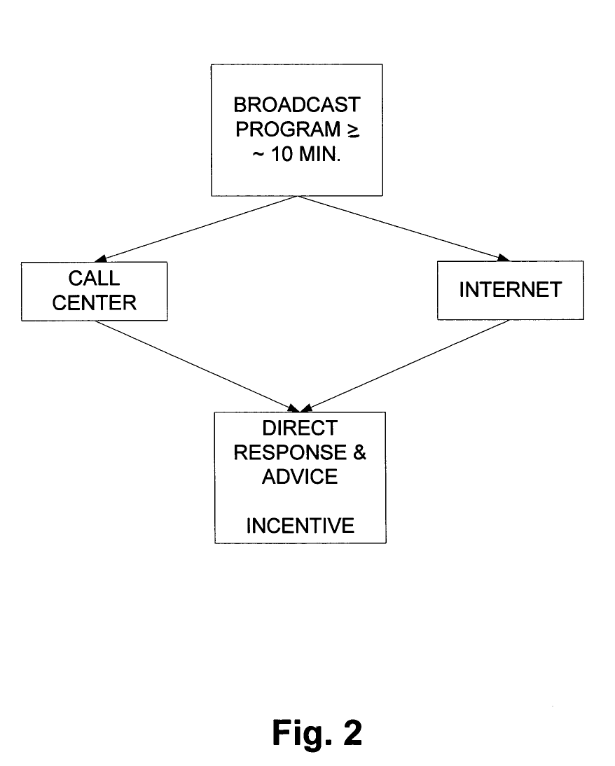

FIG. 2 schematically illustrates another exemplary embodiment of a method of marketing a product using a broadcast program that offers information and educates consumers on the product. According to this exemplary embodiment, the broadcast program may serve as a direct response marketing approach that may weave multiple media vehicles into a single execution by the consumer (e.g., contacting the designated source to request the incentive) through the offering of an incentive, for example a coupon incentive, during the program. In other words, when a consumer contacts the designated source (e.g., a call center, internet location, etc.) provided during the program to request the incentive, the consumer may also be provided access to further information about the product. Such further information may be provided directly and immediately to the consumer during the contact with the designated source. That is, the designated source will answer questions about the product from consumers who contact the designated source to request the incentive.

As an example of the further information, the consumer may be invited to ask questions about the product which may not have been answered by the television program. Such questions may be asked of a telephone operator at a call center in instances where the consumer calls the telephone number provided during the program or may be asked online at the website, for example, in a one-on-one real-time live discussion with an internet host or via electronic mail.

In addition to the consumer asking questions about the product being sold via the program, individualized advice relating to the product also may be provided. For example, in the case of a beauty care product, the consumer may be asked a series of questions relevant to determining the type of care product that would best suit that consumer's needs, and advice tailored to those responses could be provided to help the consumer choose which product or products of several may be best suited to that consumer. In the case of a hair coloring product, for example, the advice provided to the consumer may be individualized shade selection advice and/or advice on cool or warm shades. Such advice may be based on, for example, information relating to the consumer's natural hair color, desired hair color, skin tone, eye color, lifestyle, and other similar suitable characteristics of the consumer. Again, this information can be provided to the consumer directly and immediately over the phone or online, depending upon the designated source the consumer chose contacts to request the incentive offered during the program.

By obtaining personal information about the consumer through the consumer's contacting the designated source, other marketing strategies for both the product being sold via the broadcast program and other products may also be determined. The marketing strategies may be tailored based on the personal information obtained from the consumer.

Additionally, during the broadcast program or during contact with the designated source, consumers may be encouraged to complete reviews of the product once the consumer has used the product. As an example, the consumer may be encouraged to mail in, telephone in, or visit a website to provide a review of the consumer's experience with the product.

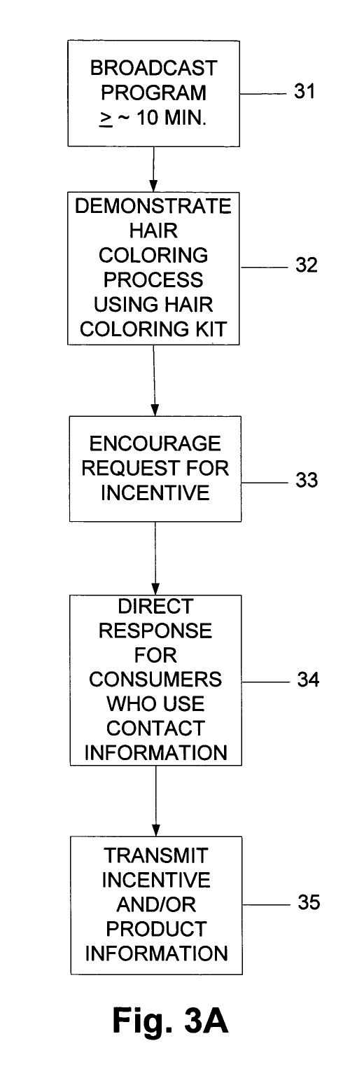

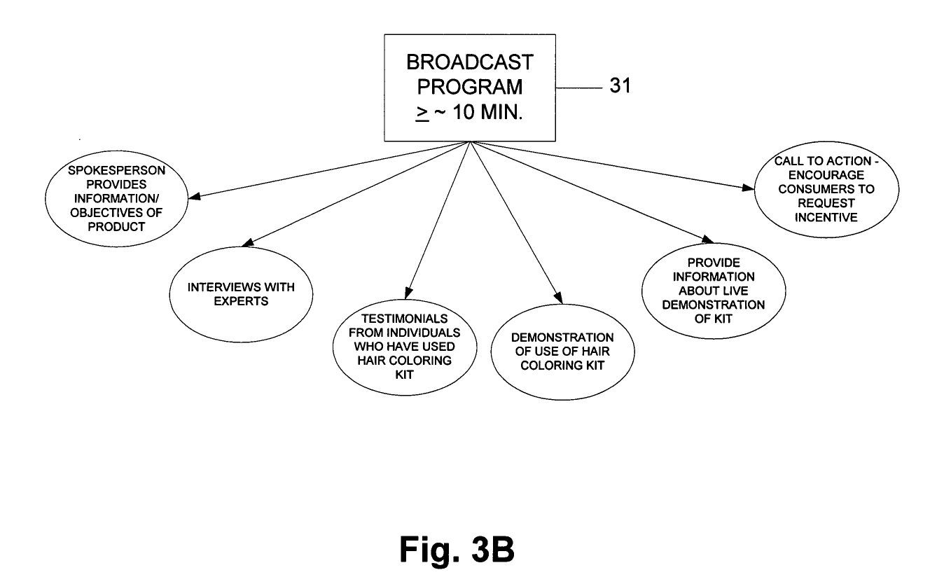

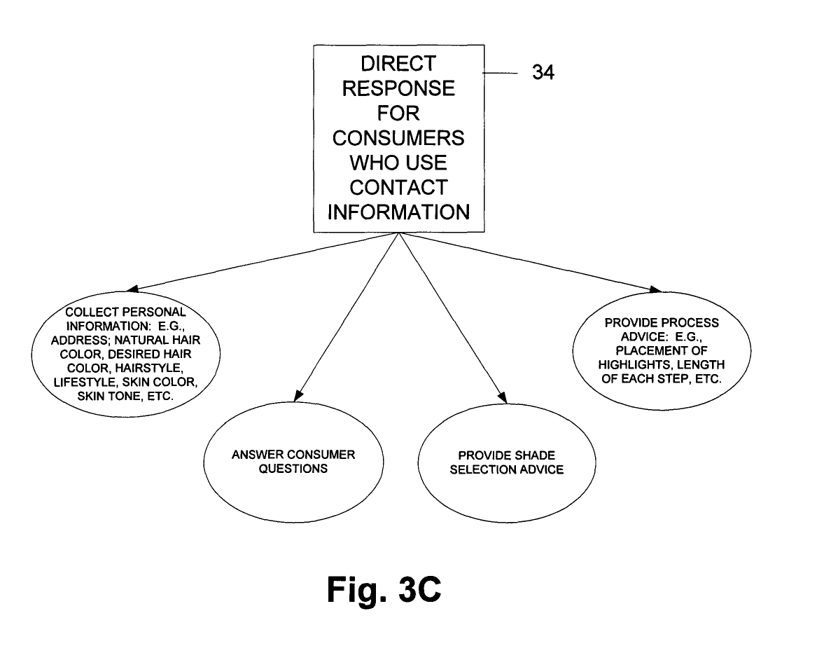

Although the various embodiments of the method of marketing a product described above may be implemented for numerous kinds of consumer products which are considered within the scope of the invention, a nonlimiting example of the type of product that can be marketed as described above includes a multi-step hair coloring product. FIGS. 3A-3C illustrate various aspects of a method of marketing such a multi-step hair coloring product.

FIG. 3A schematically illustrates a method of marketing a multi-step hair coloring product in the form of a hair coloring kit. As shown at reference numeral 31, the method comprises broadcasting a program that is at least about 10 minutes in duration, for example about 30 minutes in duration. In an exemplary aspect, the program may have roughly three different portions of about 10 minutes each in duration.

As illustrated in FIG. 3B, the program, which may be broadcast on television or over any other type of broadcast medium, including, but not limited to, at least one of radio, internet, satellite, cable, CD, DVD, magnetic or optical media, and/or tape for example, may contain several components. For example, the program may include a spokesperson who provides information about the product, explaining the contents of the product as it is sold in retail establishments and explaining what each component of the kit is and how it is used in the overall process. The spokesperson may further explain the objective of the product, which in the case of a hair coloring kit may include what coloring effect the product is intended to have, how long the process is intended to take, etc. Moreover, the spokesperson may provide information on the various color shades that the hair coloring kit is attended to effect on the hair and provide general tips to consumers for selecting an appropriate shade.

Additionally, the program may contain interviews with one or more experts in the field of hair coloring, including, for example, individuals who have expertise in using the product being sold and/or individuals who helped to develop the product. By way of example, individuals who work in research and development at the organization that developed, manufactures, and/or sells the product may be interviewed.

Also, the program may provide information to consumers about a time, place, and date in various geographical regions where consumers may go to view a live demonstration of the hair coloring kit.

As another exemplary component, the program may contain testimonials of individuals who have used the hair coloring kit. The individuals may describe their experiences with the product and the performance of the process. Further, the individuals may be shown before and after use of the hair coloring kit to alter their hair color.

According to another aspect, during the program, various individuals who have used the kit may be portrayed having a casual conversation such that each individual discusses the shade of the hair coloring kit that the individual used on her own hair and also discuss potential shades that would be best suited for the individual's hair, given such factors as skin color, skin tone, natural hair color, etc. In portraying such a casual conversation in this manner among the various individuals who used the hair coloring kit, it may be possible to weave in a discussion of all available hair colors during the program, so as to provide information about all of the available shades for the hair coloring kits to consumers through the vehicle of a casual, informal conversation.

Another portion of the program, illustrated by reference label 32 in FIG. 3A, may include a demonstration of the use of the hair coloring process associated with the product. For example, one or more steps of the multi-step process may be demonstrated by an individual, such as the spokesperson, for example, actually using the product. In particular, it may be desirable to at least demonstrate during the program how to perform critical steps of the hair coloring process. Of course, all of the steps of the multi-step process also may be demonstrated. In an exemplary aspect, the hair of the individual demonstrating the process may be shown before the hair coloring process and after the hair coloring process. The steps may be demonstrated in real time, time lapse, or a combination of both.

In an exemplary embodiment for marketing a hair coloring kit such as the one described in co-pending U.S. application Ser. No. 10/385,302, entitled “Methods and Systems for Hair Coloring and Highlighting,” filed Mar. 11, 2003, incorporated herein by reference, an individual in the program, such as the spokesperson, for example, may demonstrate the application of the hair dye to the hair, followed by the rinsing of the hair dye from the hair, followed by the application of the highlighting material to moist hair using the applicator wand supplied with the hair coloring kit. Additionally, particular placement of applying the highlight material to achieve desired effects may be demonstrated during the broadcasted program. After demonstrating the various steps of the process, the results of the hair coloring process performed may then be conveyed to consumers by showing the individual who demonstrated the process during the television program with dried hair after using the treatment.

The demonstration may include portrayals of how a particular tool is to be used. For example, during hair highlight, an applicator wand may be used to apply the highlight, and wand use techniques may be demonstrated.

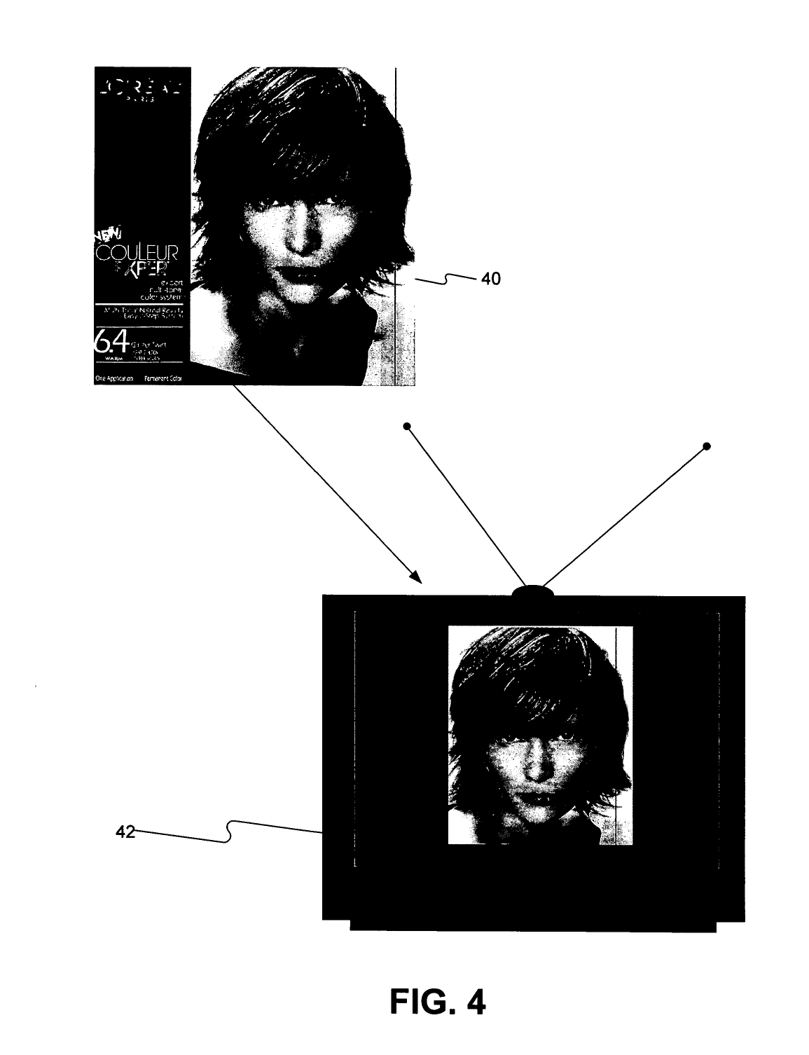

Instead of or in addition to using the spokesperson to perform the process during the program, one or several other individuals may perform the process. As shown in FIG. 4, for example, actual individuals whose likeness appear on the packaging for the hair coloring product 40 that is sold in retail establishments, or otherwise appearing in advertisements relating to the hair coloring product, may demonstrate the process, or at least portions thereof, during the program, such as a television program 42. Also, illustrations contained in the instructions provided with the hair coloring kit may be incorporated into the program. Incorporating other marketing materials into the program, in the manner described above, may provide the consumer with a degree of familiarity with the product so that the consumer may feel more comfortable purchasing and/or using the product.

Aside from demonstrating the process, the program also may provide contact information of a designated source and encourage consumers to contact the designated source to request an incentive that can be redeemed at a retail establishment when the hair coloring kit is obtained. This aspect of the program is illustrated by reference label 33 of FIG. 3A As discussed earlier, the contact information may be a telephone number and/or a website address and the designated source may be a call center or the website. During the program the consumers may be encouraged to either call the telephone number or visit the website to obtain a coupon that may redeemed for discounted purchase of the hair coloring kit at a retail establishment, for example. The providing of the contact information and the “call to action” (i.e., encouragement to contact the contact information and request the incentive) may occur several times throughout the program.

FIG. 3C schematically illustrates various components of a direct response approach, shown by reference numeral 34 of FIG. 3A, that may be implemented when consumers contact the designated source (e.g., call center or internet website) to receive the incentive (e.g., coupon). Upon the consumer contacting either a call center and/or the website address, for example, personal information about the consumer may be obtained in order to assist the consumer in shade selection for the hair coloring kit. For example, information on the consumer's natural hair color, desired hair color, skin color, skin tone, hairstyle, lifestyle, etc. may be obtained and used to provide the consumer with advice on shade selection, including, for example, providing the consumer with a list of recommended shades.

In addition, while on the phone or visiting the website address, further information regarding the hair coloring-process, for example, individualized advice on use of the process, such as, for example, placement of the highlights, amount of the highlights, length of time to perform each of the hair dyeing and/or the hair highlighting steps, etc. may be provided to the consumer. Further the designated source may field questions from consumers who contact the designated source to obtain the coupon or to request further information about the hair coloring kit.

Among the personal information that may be collected from the consumer who has contacted either the call center or the website is a mailing address and/or an electronic mail address to which a coupon can be transmitted to the consumer. Transmission of the coupon and/or other information to the consumer is illustrated as reference numeral 35 in FIG. 3A. Upon receipt of the coupon, the consumer may visit a retail establishment to obtain the hair coloring kit at a discounted price.

As described above, the coupon may have a code associated with it such that redemption of the coupon may be tracked. In such a case, a communication may be sent to a consumer who did not redeem the coupon, reminding that consumer that the coupon may still be used to purchase the product. Alternatively, in the case of a consumer who redeemed the coupon, a communication may be sent to that consumer at a preselected time period from the date of purchase of the hair coloring kit reminding the consumer that it may be time to use the kit again to color the hair. The preselected time period may be based on, for example, a time period after which it is expected that effects of the coloring process have either substantially diminished or no longer exist. Also, a survey, for example a marketing survey, may be transmitted to consumers who have redeemed the coupon, and the consumer may be requested to complete and return the survey. The survey may be transmitted to the consumer either via postal mail or electronic mail, depending on the designated source the consumer initially contacted to request the coupon.

As also discussed above, with the transmission of the coupon to the consumer, other information about the hair coloring kit also may be provided. For example, a list of retail establishments carrying the hair coloring kit and in the geographic area of a location of the consumer, for example in the proximity of the consumer's home, work, and/or other convenient location may be provided. Also, advice on shade selection and/or a personalized shade palette may be provided to the consumer along with the transmission of the coupon.

Additionally, the code may be used to track whether or not consumers are obtaining the hair coloring kit. This code and/or other information obtained when consumers contact the designated source may be used to generate consumer profiles and to categorize consumers based on the generated profiles. An example of a category that may be created based on the generated profile is a “club” category that indicates a consumer's dedication to the hair coloring kit. Such consumers, who may be categorized as a “club” member based on frequent purchase of the hair coloring kit and/or frequent contact of the designated source may receive special offers, incentives, and/or other advantages as a means of rewarding those consumers for their dedication to the hair coloring kit.

Although the various steps illustrated in FIG. 3A are shown sequentially, those skilled in the art would understand that the various components of the broadcast program, including those components shown in FIG. 3B and steps 32 and 33 of FIG. 3A, may occur in various orders. For example, a demonstration of various steps of the process may occur throughout the entire program and be interspersed with testimonials, interviews with experts, and other information about the hair coloring kit. Further, the contact information and encouragement to consumers to request a coupon may occur at any time, and indeed several times, throughout the program.

The invention also may include a broadcast medium containing a program, aspects of which are described herein. The broadcast medium may be one or more of a recording of the program on tape, CD, DVD, or any other digital, optical, magnetic, and/or other medium capable of storing the program.

Also, those skilled in the art will recognize that the steps illustrated in the various figures of this application are exemplary only and the methods of marketing described herein may include more or less steps than those shown in the exemplary embodiments of the figures. Likewise, the various components of the steps illustrated in FIGS. 3B and 3C are exemplary only.

Although much of this application describes methods of marketing a hair coloring kit, it is not intended that the invention be limited to such products. For example, the methods described herein could apply to a variety of cosmetic products, such as make-up products and/or skin care products, for example. Also, in its broadest aspects, the present invention could be used to market a variety of other types of mass consumer products. Furthermore, the various steps and components and arrangement of those steps and components described herein are illustrative and exemplary only and one of ordinary skill in the art would recognize that these can be changed as desired and depending on the nature of the product being marketed.

It will be apparent to those skilled in the art that various modifications and variations can be made to the methodology. Thus, it should be understood that the invention is not limited to the examples discussed in the specification. Rather, the modifications and variations are intended to be covered.

What is claimed is:

1. A method of marketing a mass consumer product, the method comprising:
providing retail establishments with quantities of the mass consumer product;
broadcasting a program of at least about 10 minutes in duration, the program containing information about the mass consumer product;
during the program, encouraging the consumers to request an incentive associated with a prospective purchase of the product; and
enabling consumers who visit at least one of the retail establishments to redeem the incentive at the time of obtaining the product.

2. The method of claim 1, further comprising demonstrating how to use the product during the broadcasting of the program.

3. The method of claim 2, wherein the demonstrating includes having at least one individual use the product.

4. The method of claim 3, wherein the demonstrating includes having multiple individuals use the product and describe their use of the product.

5. The method of claim 3, wherein the individual is an individual whose likeness appears on packaging associated with the product.

6. The method of claim 3, wherein the individual is an individual whose likeness appears on advertising material associated with the product.

7. The method of claim 1, wherein the encouraging consumers includes providing contact information for consumers to use to request the incentive.

8. The method of claim 7, wherein the contact information is at least one of a telephone number and an internet address.

9. The method of claim 7, wherein the encouraging occurs a plurality of times during the program.

10. The method of claim 1, further comprising transmitting the incentive to consumers.

11. The method of claim 10, further comprising transmitting other information about the product to the consumers along with the incentive.

12. The method of claim 11, wherein the other information includes information requested by the consumers during the request for the incentive.

13. The method of claim 11, wherein the other information includes a list of retail establishments that carry the product and are in geographical proximity to respective locations of the consumers.

14. The method of claim 1, wherein broadcasting the program includes broadcasting a program of approximately one half of an hour in duration.

15. The method of claim 10, wherein the transmitting the incentive includes transmitting an incentive associated with a unique code.

16. The method of claim 15, wherein the code provides information on redemption of the incentive.

17. The method of claim 10, wherein the code provides information for future marketing efforts for the product.

18. The method of claim 1, wherein the product comprises a personal care product, the application of which is designed to occur in multiple steps, and wherein the information contained in the program includes at least one demonstration of the multiple steps.

19. The method of claim 18, wherein the product comprises a hair coloring kit for performing a multi-step hair coloring process.

20. The method of claim 19, wherein the multi-step hair coloring process comprises applying highlighting material to moist hair and the demonstrating includes demonstrating the applying of the highlight material to moist hair.

21. The method of claim 1, wherein the incentive includes a coupon for purchasing the product at a reduced price and the method further comprises transmitting coupon to the consumer.

22. The method of claim 1, wherein the incentive includes a rebate received by the consumer for mention of the program upon obtaining the product during a visit to at least one of the retail establishments.

23. The method of claim 1, wherein the incentive includes a mail-in rebate certificate which is received by the consumer by mentioning the program upon obtaining the product during a visit to at least one of the retail establishments.

24. The method of claim 1, wherein the incentive includes a free gift to the consumer upon mention of the program and obtaining the product during a visit to at least one of the retail establishments.

25. The method of claim 1, wherein the broadcasting of the program includes broadcasting the program on television.

26. The method of claim 1, wherein the broadcasting of the program includes broadcasting the program on at least one of radio, television, satellite, cable, internet, CD, DVD, magnetic media, and optical media.

27. The method of claim 1, wherein the mass consumer product is at least one of a personal care product and a cosmetic product.

28. A method of marketing a mass consumer personal treatment product, the method comprising:
broadcasting a program of at least about 10 minutes in duration;
during the broadcasted program, demonstrating a multi-step process using the mass consumer personal treatment product, wherein at least a portion of the demonstrating of the process is performed by at least one individual whose likeness appears on packaging associated with the personal treatment product;
during the broadcasted program, providing consumers with contact information to receive an incentive for a prospective purchase of the product;
fielding requests from consumers who use the contact information to receive the incentive;
transmitting the incentive to requesting consumers; and
encouraging consumers to redeem the incentive during a visit to at least one retail establishment in connection with obtaining the mass consumer personal care product.

29. The method of claim 28, wherein the mass consumer personal care product comprises a hair coloring kit for performing a multi-step hair coloring process.

30. The method of claim 29, wherein the multi-step hair coloring process comprises applying highlighting material to moist hair and the demonstrating of the at least one step includes demonstrating the applying of the highlight material to moist hair.

31. The method of claim 28, wherein the at least one individual is an individual whose likeness appears in advertising material associated with the product.

32. The method of claim 28, wherein the incentive comprises a coupon to purchase the product at a reduced price at the at least one retail establishment.

33. A broadcast medium, comprising:
a program of at least about 10 minutes in duration, the program comprising information about a mass consumer product which is provided in quantities to retail establishments,
wherein the program further includes encouraging consumers to request an incentive associated with a prospective purchase of the product, the incentive being described in the program as redeemable by the consumers during a visit to at least one of the retail establishments at the time of obtaining the product.

34. The broadcast medium of claim 33, wherein the program comprises a demonstration of how to use the product.

35. The broadcast medium of claim 34, wherein the demonstration includes a demonstration wherein at least one individual uses the product.

36. The broadcast medium of claim 35, wherein the demonstration includes a demonstration wherein multiple individuals use the product and describe their use of the product.

37. The broadcast medium of claim 35, wherein the individual is an individual whose likeness appears on packaging associated with the product.

38. The broadcast medium of claim 35, wherein the individual is an individual whose likeness appears on advertising material associated with the product.

39. The broadcast medium of claim 33, wherein the program comprises providing contact information to consumers to use to request the incentive.

40. The broadcast medium of claim 33, wherein the program is approximately one half of an hour in duration.

41. The broadcast medium of claim 33, wherein the product comprises a personal care product the application of which is designed to occur in multiple steps, and wherein the information contained in the program includes at least one demonstration of the multiple steps.

42. The broadcast medium of claim 33, wherein the broadcast medium is a recording stored on at least one of digital, magnetic, and optical storage medium.

43. The broadcast medium of claim 33, wherein the broadcast medium is at least one of tape, CD, and DVD.
